(19) United States
(12) Patent Application Publication
(10) Pub. No.: US 2006/0226718 A1
(43) Pub. Date: Oct. 12, 2006

(54) Closed enclosure electric machine

(76) Inventor: Tai-Her Yang, Si-Hu Town (TW)

Correspondence Address: RABIN & BEDRO, P.C., Suite 500, 1101 14th Street, N.W., Washington, DC, 20005, US

(21) Appl. No.: 11/101,417

(22) Filed: Apr. 8, 2005

(51) Int. Cl. H02K 9/00; H02K 3/24; H02K 5/00; H02K 1/00

(52) U.S. Cl. 310/59; 310/64; 310/89; 310/216

(57) ABSTRACT

An AC or DC, internal or external rotation rotary or linear electric machine with magnetic poles; one or a plurality radius or circumambient air chamber and radius or slotted through hole disposed between abutted magnetic poles, and optionally one or a plurality of notch, through hole, or slotted through hole formed respectively at both end casing along a neutral line of magnetic pole to constitute an air current passage; a circular radiation casing connecting through the internal of the electric machine via the notch, through hole or slotted hole being provided externally to the magnetic path; a space being defined between the circular heat sink casing and the outer casing of the magnetic path to admit airflow; the circular heat sink and closed enclosures at both ends constitute a closed enclosure electric machine to allow circulation of airflow inside the electric machine and to be discharged into the ambient through the casing of the circular heat sink.

### BACKGROUND OF THE INVENTION

(a) Field of the Invention

The present invention is related to a closed enclosure electric machine adapted with air chamber and radius through hole, and more particularly, to an AC or DC rotary electric machinery of provided with magnetic pole structure, one or a plurality radius or circumambient air chamber and radius or slotted through hole disposed in the middle between abutted magnetic poles, and optionally one or a plurality of notch, through hole, or slotted through hole formed respectively at both ends at the proximate end casing along a neutral line of magnetic pole to constitute an air current passage. A circular radiation casing connecting through the internal of the electric machine via the notch, through hole or slotted hole is provided externally to the structure of the magnetic path; a space is defined between the circular heat sink casing and the outer casing of the magnetic path to admit airflow. The circular heat sink and closed enclosures at both ends of the electric machine constitutes a closed enclosure electric machine to allow circulation of airflow created by the heat accumulated inside the electric machine to discharge the heat into the ambient through the casing of the circular heat sink.

(b) Description of the Prior Art

Conventional electric machine in a structural type containing a longer rotor in smaller diameter is vulnerable to thermal failure by accumulation of heat in the mid section due to poor air circulation.

### SUMMARY OF THE INVENTION

The primary purpose of the present invention is to provide an AC or DC internal or external rotation rotary electric machine or linear machine provided with magnetic pole structure. One or a plurality radius or circumambient air chamber and radius or slotted through hole disposed in the middle between abutted magnetic poles, and optionally one or a plurality of notch, through hole, or slotted through hole formed respectively at both ends at the proximate end casing along a neutral line of magnetic pole to constitute an air current passage. A circular radiation casing connecting through the internal of the electric machine via the notch, through hole or slotted hole is provided externally to the structure of the magnetic path; a space is defined between the circular heat sink casing and the outer casing of the magnetic path to admit airflow. The circular heat sink and closed enclosures at both ends of the electric machine constitutes a closed enclosure electric machine to allow circulation of airflow created by the heat accumulated inside the electric machine to discharge the heat into the ambient through the casing of the circular heat sink.

### BRIEF DESCRIPTION OF THE DRAWINGS

FIG. 1 is a perspective view of a preferred embodiment of the present invention.

FIG. 2 is a sectional view of the first preferred embodiment of the present invention as assembled.

FIG. 3 is a front view of the first preferred embodiment of the present invention as assembled.

FIG. 4 is a sectional view of a second preferred embodiment of the present invention having a slotted through hole in radius provided to the magnetic path between magnetic poles.

FIG. 5 is a front view of the second preferred embodiment of the present invention.

FIG. 6 is a sectional view of a third preferred embodiment of the present invention having two longitudinally slotted through holes provided to the magnetic path between magnetic poles.

FIG. 7 is a front view of the third preferred embodiment of the present invention.

FIG. 8 is a sectional view of a fourth preferred embodiment of the present invention having an inclined slotted through hole provided to the magnetic path between magnetic poles.

FIG. 9 is a front view of the fourth preferred embodiment of the present invention.

FIG. 10 is a sectional view of a fifth preferred embodiment of the present invention having multiple laterally slotted through holes provided to the magnetic path between magnetic poles.

FIG. 11 is a front view of the fifth preferred embodiment of the present invention.

FIG. 12 is a sectional view of a sixth preferred embodiment of the present invention having multiple slotted through holes in a row provided to the magnetic path between magnetic poles.

FIG. 13 is a front view of the sixth preferred embodiment of the present invention.

FIG. 14 is a sectional view of a seventh preferred embodiment of the present invention having multiple rows of through holes in radius provided to the magnetic path between magnetic poles.

FIG. 15 is a front view of the seventh preferred embodiment of the present invention.

FIG. 16 is a perspective view showing that the magnetic path of a ninth preferred embodiment of the present invention is comprised of multiple axially laminated permeable sheets each in different diameter from another.

FIG. 17 is a side view of the ninth preferred embodiment of the present invention.

FIG. 18 is a front view of the ninth preferred embodiment of the present invention.

FIG. 19 is a front view of a tenth preferred embodiment of the present invention having longitudinally slotted through holes provided on the external rotor of an external rotation electric machine.

FIG. 20 is a sectional view taken from X-X′ of FIG. 19.

FIG. 21 is a sectional view taken from Y-Y′ of FIG. 19.

FIG. 22 is a front view of an eleventh preferred embodiment of the present invention having two through holes in radius provided on the external rotor of an external rotation electric machine.

FIG. 23 is a side view of the eleventh preferred embodiment of the present invention.

### DETAILED DESCRIPTION OF THE PREFERRED EMBODIMENTS

The present invention is to provide an AC or DC internal or external rotation rotary electric machine or linear machine provided with magnetic pole structure. One or a plurality radius or circumambient air chamber and radius or slotted through hole disposed in the middle between abutted magnetic poles, and optionally one or a plurality of notch, through hole, or slotted through hole formed respectively at both ends at the proximate end casing along a neutral line of magnetic pole to constitute an air current passage. A circular radiation casing connecting through the internal of the electric machine via the notch, through hole or slotted hole is provided externally to the structure of the magnetic path; a space is defined between the circular heat sink casing and the outer casing of the magnetic path to admit airflow. The circular heat sink and closed enclosures at both ends of the electric machine constitute a closed enclosure electric machine to allow circulation of airflow created by the heat accumulated inside the electric machine to discharge the heat into the ambient through the casing of the circular heat sink. To facilitate describing those functional characteristics of the preferred embodiments, a bi-polar electric machine is taken as an example.

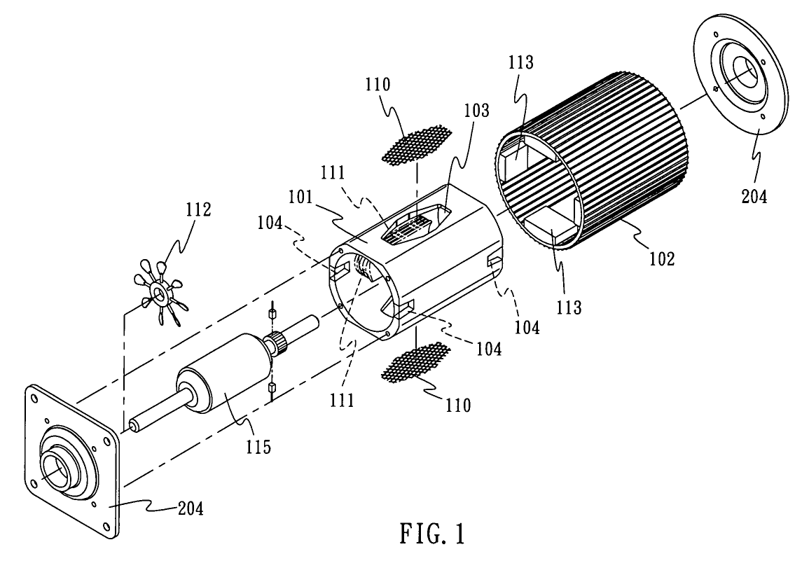

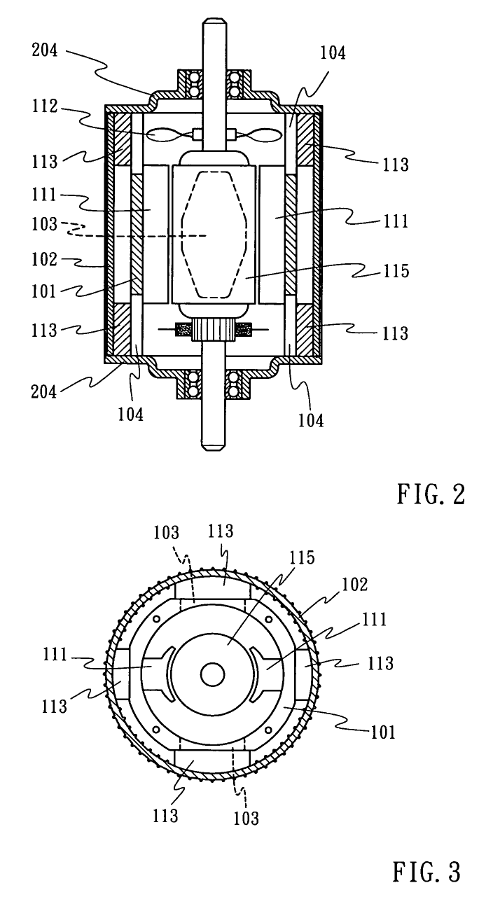

Referring to FIGS. 1, 2, and 3, a first preferred embodiment of the present invention is comprised of an integrated or combined magnetic path construction of an electric machine coupled to a construction of relatively operating electric machine. Wherein, each magnetic path is provided with multiple magnetic poles of different polarities including magnetic core of permanent magnetic pole or winding excited and exciting winding. The area of the cross-section of permeability of the construction of magnetic path among those magnetic poles is generally determined by the average or approximately average flux density of the magnetic field; one or a plurality of radius or slotted through hole is disposed between two abutted magnetic poles. FIG. 1 is a perspective view of a preferred embodiment of the present invention. FIG. 2 is a sectional view of the first preferred embodiment of the present invention as assembled. FIG. 3 is a front view of the first preferred embodiment of the present invention as assembled. The first preferred embodiment is essentially comprised of:

a magnetic path structure 101: comprised of a permeable material, is provided with a magnetic pole 111 serving as a stator; the magnetic pole 111 relates to a permanent or winding exciting or a winding comprised of a rotation magnetic field to match another electric machine structure 115 operating as an electric machine;

the magnetic pole 111: may be comprised of a plurality of poles, one or multiple radius through hole 103 or longitudinally slotted through hole or inclined slotted hole or laterally slotted hole is disposed among the poles, one or multiple flared notch 104 or through hole or slotted through hole may be optionally provided on both ends along a neutral line of each magnetic pole at where closed to an end casing; a circular heat sink casing 102 comprised of a permeable or non-permeable material is axially provided to the outer side of the magnetic pole 111; a space is defined to allow a fluid to flow between the circular heat sink casing 102 and the magnetic path structure 101 thus to constitute a airflow passage with the radius through hole 103 or the slotted through hole from the structure of the magnetic path; meanwhile, an optional strainer 110 may be provided in the airflow passage for the hotter airflow inside the electric machine to circulate by convection thus to dissipate the accumulated heat inside the electric machine to the ambient through the circular heat sink casing 102; and both end casings 204 respectively provided at both ends of the magnetic path structure and the circular heat sink casing 102 are enclosed to each other to form a construction of closed enclosure electric machine;

the end casing 204: provided to incorporate the relatively rotary electric machine structure 115 and the magnetic path structure 101 into a construction of electric machine to provide a foundation of mechanical stability for the operation of the electric machinery, also ensures closed incorporation with the circular heat sink casing 102; the end casing 204 may be made of permeable or non-permeable material; in case of permeable material, a non-permeable separation ring must be disposed between the end casing 204 and a spindle to avoid creating flux loop if the spindle is made permeable; and the non-permeable separation ring is omitted if the end casing is made non-permeable;

the heat sink casing 102: made of permeable or non-permeable material, including aluminum, copper, or other non-permeable materials with good heat conduction, or permeable and heat conduction materials; when made of permeable material, the heat sink casing 102 may become an integrated part of the magnetic path among magnetic poles; when applied in DC or AC rectifier type of electric machine, an optional inverting magnetic pole may be provided as applicable; the circular heat sink casing 102 may be made in circular, polygonal or other geometric shape containing a support block 103 for the combination of the magnetic path structure 101 and the end casing 204; the support block 113 is made in a form without compromising the circulating airflow in the magnetic path; and the support block 113 may be omitted if direct combination is permitted between the circular heat sink casing 102 and the magnetic path structure 101 or the end casing 204 without comprising the circulation of the airflow; and

an airflow pump fan 112: related to an operational airflow pump fan driven by the spindle of the electric machine, or an airflow pump fan driven by an independent motor to actively pump the hotter airflow accumulated inside the electric machine to circulate inside an air chamber formed by the circular heat sink casing 204 so to facilitate the heat dissipation for the electric machine.

Based on those principles described above, various types of construction are available for the magnetic path to select in achieving the same benefits. Designs of various applications for the closed enclosure electric machine provided with circumambient air chamber and radius through hole are described in the following preferred embodiments of the presence invention.

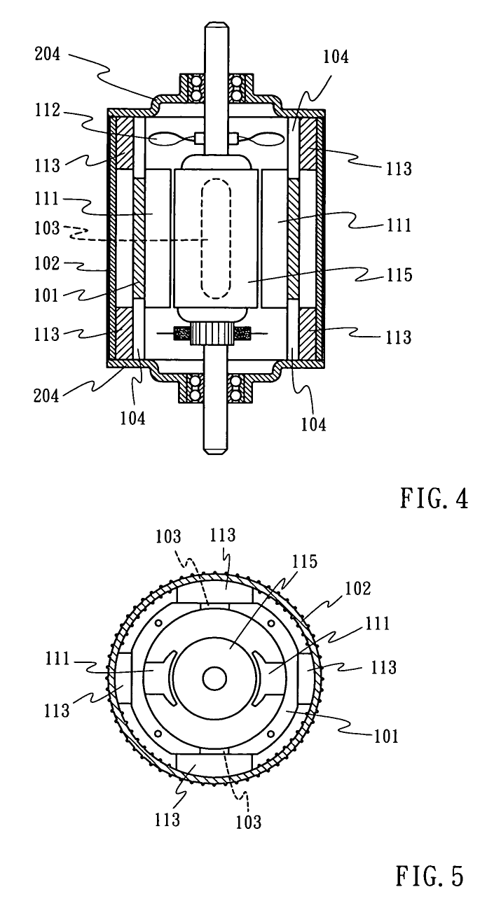

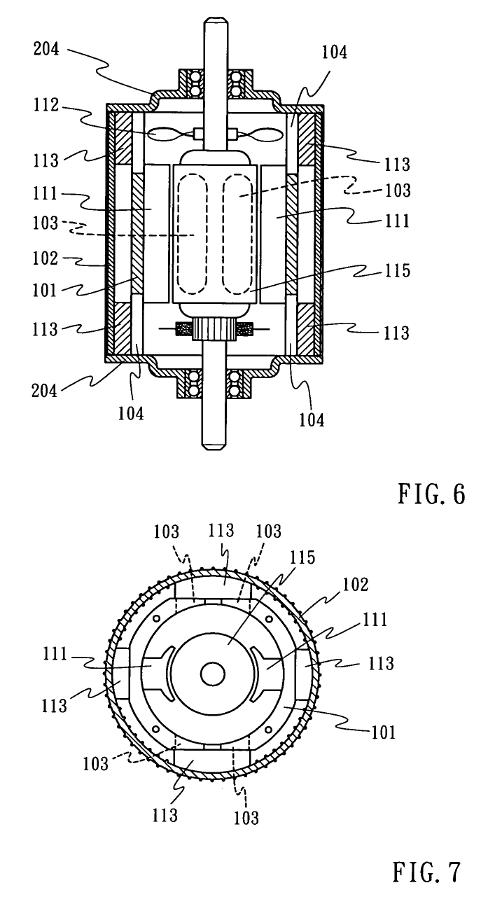

FIGS. 4 and 5 show a second preferred embodiment of the present invention wherein a longitudinally slotted through hole is provided between magnetic poles to serve as an airflow passage. FIG. 4 is a sectional view of a second preferred embodiment of the present invention having an additional slotted through hole 103 in radius provided to the magnetic path between magnetic poles; and FIG. 5 is a front view of the second preferred embodiment of the present invention. Furthermore, as illustrated in FIGS. 6 and 7 two longitudinally slotted through holes are provided at an angular location of the electric machine between two abutted magnetic poles. FIG. 6 is a sectional view of a third preferred embodiment of the present invention having two longitudinally slotted through holes provided to the magnetic path between magnetic poles; and FIG. 7 is a front view of the third preferred embodiment of the present invention.

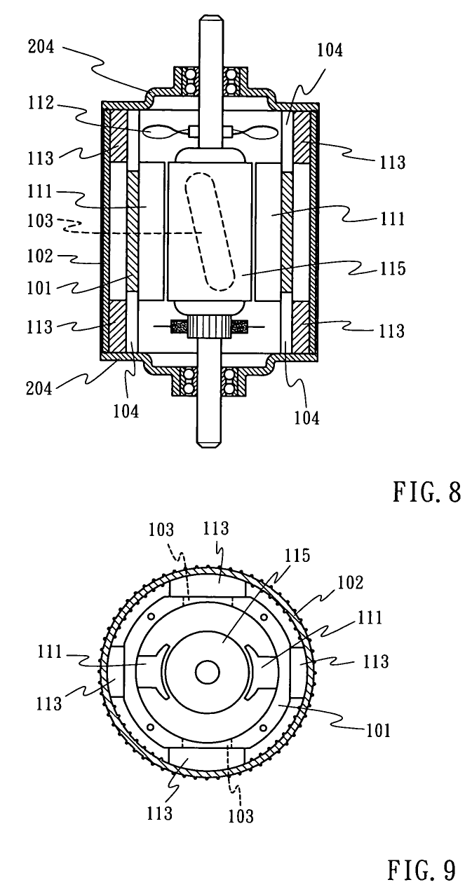

The magnetic path structure 101 of the present invention may provide between the poles of the magnetic path structure 101 one or a plurality of slotted through hole 103 oblique to a polar axis of the magnetic field. FIG. 8 is a sectional view of a fourth preferred embodiment of the present invention having an inclined slotted through hole provided to the magnetic path between magnetic poles; and FIG. 9 is a front view of the fourth preferred embodiment of the present invention.

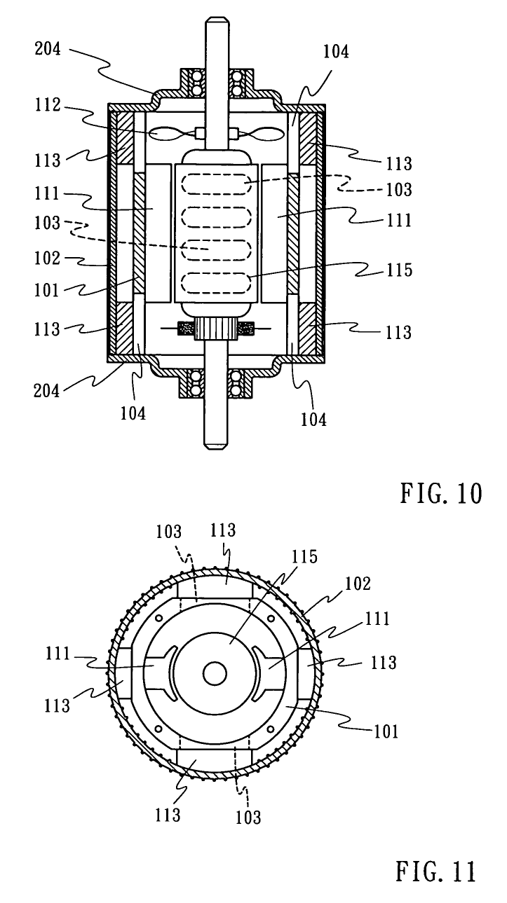

The magnetic path structure 101 of the present invention may provide between the poles of the magnetic path structure 101 one or a plurality of laterally slotted through hole 103. FIG. 10 is a sectional view of a fifth preferred embodiment of the present invention having multiple slotted through holes laterally provided to the magnetic path between magnetic poles; and FIG. 11 is a front view of the fifth preferred embodiment of the present invention.

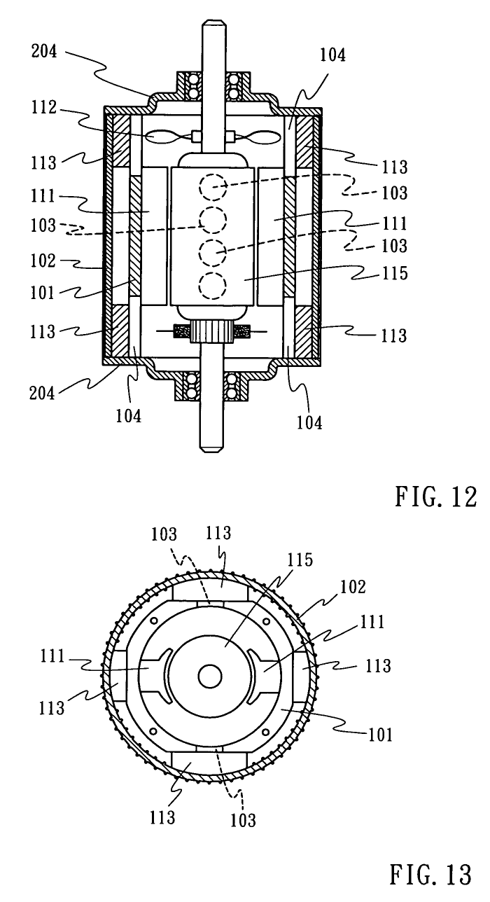

The magnetic path structure 101 of the present invention may provide between the poles of the magnetic path structure 101 a row of multiple through holes 103 in radius. FIG. 12 is a sectional view of a sixth preferred embodiment of the present invention having multiple slotted through holes in a row provided to the magnetic path between magnetic poles; and FIG. 13 is a front view of the sixth preferred embodiment of the present invention.

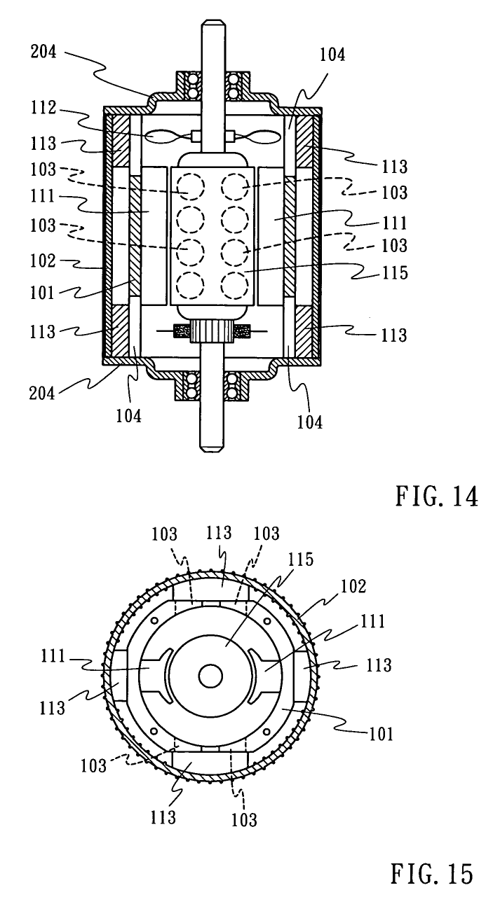

The magnetic path structure 101 of the present invention may provide between the poles of the magnetic path structure 101 multiple rows of through holes 103 in radius. FIG. 14 is a sectional view of a seventh preferred embodiment of the present invention having multiple rows of through holes in radius provided to the magnetic path between magnetic poles; and FIG. 15 is a front view of the seventh preferred embodiment of the present invention.

The electric machine construction of the present invention may be applied in an AC motor or a generator, or in series, shunt, or compound excitement AC or AC brush motor or generator, or applied in a DC or brushless or brush motor or generator with its magnetic field comprised of a permanent magnet. The mechanical structure of the electric machine is further comprised based on electric machinery characteristics operating on the same principles of multi-pole external or internal rotation type of rotary electric machine, magnetic filed rotation type of rotary electric machine, or armature rotation type of rotary electric machine, or magnetic field and armature rotor dual rotation type of rotary electric machine. The type of the construction of the electric machine includes cylinder, conic, or disk rotation type of rotary electric machine, or linear drive construction of the electric machine. According to those operating principles as described above, the structure of the magnetic path for the electric machine may be made integrated or combined components, or laminated with multiple permeable sheets, or have only the magnetic poles to be comprised of laminated multiple permeable sheets leaving the remaining magnetic path made in block structure to constitute the magnetic path in the magnetic field to form the magnetic path structure with a relay magnetic path.

The magnetic path structure entirely or partially made of laminated permeable sheets of the present invention is described in the following preferred embodiments of the present invention.

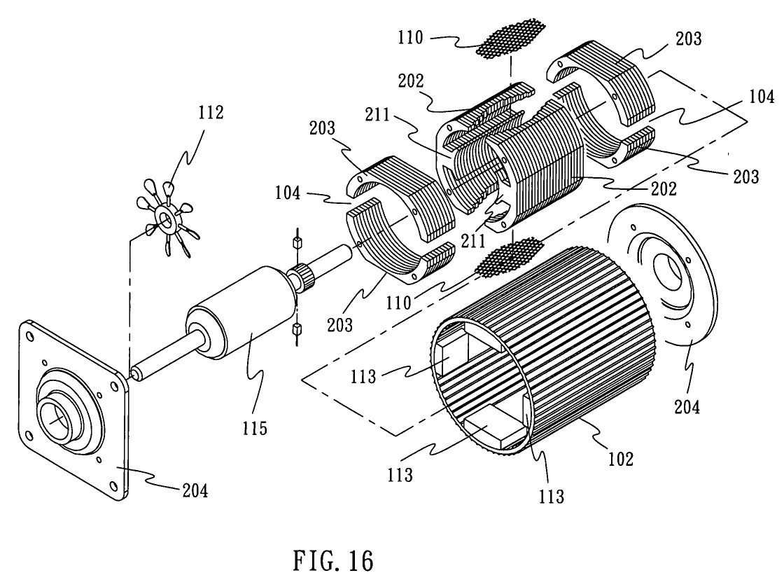

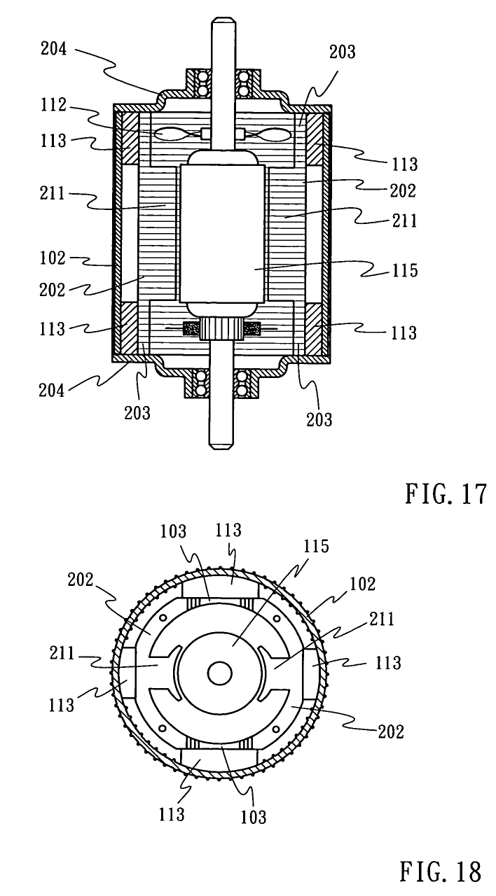

FIG. 16 is a perspective view showing that the magnetic path of a ninth preferred embodiment of the present invention is comprised of multiple axially laminated permeable sheets each in different diameter from another. FIG. 17 is a side view of the ninth preferred embodiment of the present invention; and FIG. 18 is a front view of the ninth preferred embodiment of the present invention. The magnetic path structure illustrated in FIGS. 16, 17, and 18 comprised of multiple permeable sheets axially laminated from the mid of the magnetic pole towards both end casings with the axially permeable area of each permeable sheet flared in radius is characterized as follows:

a field magnetic path 202: related to one that axially extending towards the end casings in flared cross-sectional areas of different magnetic path and outer diameter is comprised of multiple permeable sheets. Though all the permeable sheets have the same outer diameter, their field magnetic paths are comprised of permeable sheets of different magnetic path widths axially laminated from the mid of the magnetic pole towards both sides, and the structure of the permeable sheet closer to the end casing has wider magnetic path so to ensure that the flux density of the field magnetic path tends to evenly distributed; the filed magnetic path structure includes a stator magnetic pole 211 comprised of multiple poles; and the magnetic pole 211 is permanent or winding excited, or winding that constitutes a rotary magnetic field so to adapt to another electric machine structure 115 engaging in relative operation of functions of an electric machine;

the magnetic pole 211: of multiple poles, one or a plurality of radius through hole 103 or slotted through hole is disposed between magnetic poles; one or a plurality of flared notch 104 or through hole or slotted through hole is made as required with its outer side surrounded by with the circular heat sink casing 102 made of permeable or non-permeable material; a space to admit flow of fluid is defined among the circular heat sink casing 102, the field magnetic path 202 and a relay magnetic path 203 to create airflow passage with the radius through hole 103 or the slotted through hole from the structure of the magnetic path; an optional strainer 110 is disposed in the airflow passage to exercise circulation by convection with the hotter airflow inside the electric machine so to dissipate the accumulated heat inside the electric machine to the ambient through the circular heat sink casing 102; and both end casings 204 respectively provided at both ends of the structure of the magnetic path are enclosed with the circular heat sink casing 102 to form a closed enclosure structure of electric machine;

the relay magnetic path 203: to be coupled to both sides of the filed magnetic path 202 for the filed magnetic path, the relay magnetic path, and a rotor between magnetic poles to constitute a closed flux for operating on electric machinery effects; the relay magnetic path may be comprised of permeable sheet indicating when viewed axially a closed loop in relation to the central location of the abutted magnetic pole to couple the filed magnetic path to the flux of the abutted magnetic pole; and the relay magnetic path is alternatively comprised of a block type of permeable material;

the end casing 204: provided to incorporate the relatively rotary electric machine structure 115 and the magnetic path structure (including the filed magnetic path 202 and the relay magnetic path 203) into a construction of electric machine to provide a foundation of mechanical stability for the operation of the electric machinery, also ensures closed incorporation with the circular heat sink casing 102; the end casing 204 may be made of permeable or non-permeable material; in case of permeable material, a non-permeable separation ring must be disposed between the end casing 204 and a spindle to avoid creating flux loop if the spindle is made permeable; and the non-permeable separation ring is omitted if the end casing is made non-permeable;

the circular heat sink 102: made of permeable or non-permeable material, including aluminum, copper, or other non-permeable materials with good heat conduction, or permeable and heat conduction materials; when made of permeable material, the heat sink casing 102 may become an integrated part of the magnetic path among magnetic poles; when applied in DC or AC rectifier type of electric machine, an optional inverting magnetic pole may be provided as applicable; the circular heat sink casing 102 may be made in circular, polygonal or other geometric shape containing a support block 103 for the combination of the magnetic path structure 101 and the end casing 204; the support block 113 is made in a form without compromising the circulating airflow in the magnetic path; and the support block 113 may be omitted if direct combination is permitted between the circular heat sink casing 102 and the magnetic path structure 101 or the end casing 204 without comprising the circulation of the airflow; and

an airflow pump fan 112: related to an operational airflow pump fan driven by the spindle of the electric machine, or an airflow pump fan driven by an independent motor to actively pump the hotter airflow accumulated inside the electric machine to circulate inside an air chamber formed by the circular heat sink casing 204 so to facilitate the heat dissipation for the electric machine.

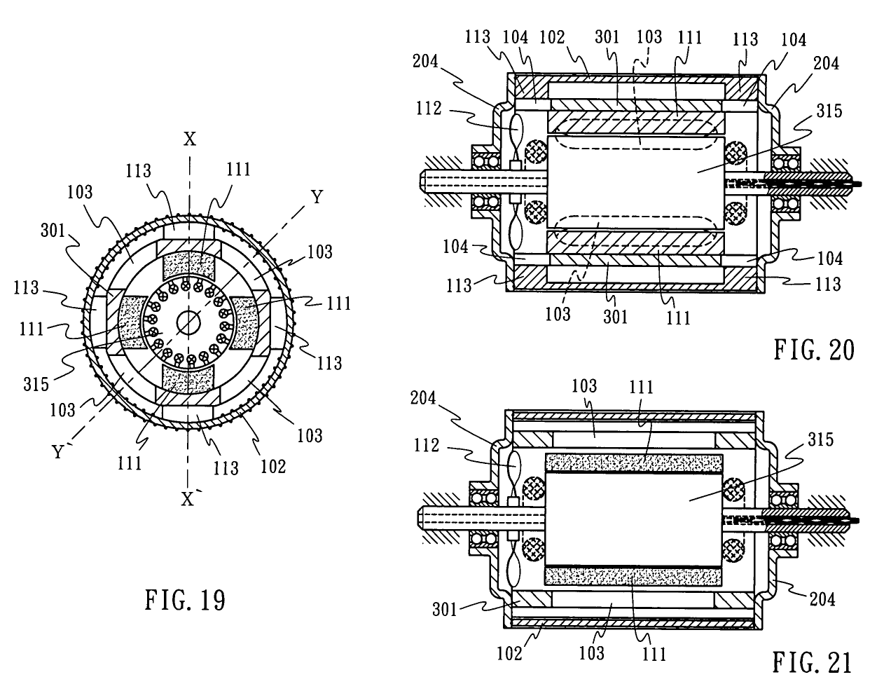

This closed enclosure electric machine provided with a circumambient air chamber and radius through hole is further applied in the external rotation type of electric machine as illustrated in FIGS. 19, 20, and 21. FIG. 19 is a front view of a tenth preferred embodiment of the present invention having longitudinally slotted through holes provided on the external rotor of an external rotation electric machine. FIG. 20 is a sectional view taken from X-X′ of FIG. 19; and FIG. 21 is a sectional view taken from Y-Y′ of FIG. 19. The tenth preferred embodiment is essentially comprised of:

a structure of magnetic path 301: relates to a rotor mounted to the external rotation part of the electric machine to function as an electric machine; the external rotation part of the electric machine is comprised of permanent or winding magnetic pole or rectifier type armature or cage rotor; the magnetic pole of the external rotation part of the electric machine may be comprised of multiple poles to engage in interactive rotation with a stationary part 315 of a stationary electric machine of relative motion; the stationary part 315 of the stationary electric machine serves as a stator of the electric machine with its electric machine structure of the magnetic filed permanent or winding excited, or of winding constituting rotary magnetic filed depending on the structural type of the external rotation part of the adapted electric machine; the magnetic path structure 301 is comprised of material of good permeability to transmit the flux among magnetic poles of the external rotation part of the electric machine, one or a plurality radius through hole 103 or longitudinally slotted through hole or inclined slotted hole or laterally slotted hole is provided between magnetic poles; one or multiple flared notch 104 or through hole or slotted through hole may be optionally provided on both ends along a neutral line of each magnetic pole at where closed to an end casing to create an airflow passage; a circular heat sink casing is disposed externally to the magnetic path structure; a space is defined between the circular heat sink casing and the outer casing of the magnetic path to admit airflow; the space is also connecting through inside the electric machine through the airflow passage formed by the notch, through hole or slotted through hole; both circular heat sink casings and the both closed ends of the electric machine constitute a structure of closed enclosure electric machine for the hotter airflow accumulated inside the electric machine to circulate through the airflow passage and dissipated into the ambient through the circular heat sink casing;

the end casing 204: provided to incorporate the magnetic path 301 and the stator 315 of stationary electric machine into a construction of electric machine to provide a foundation of mechanical stability for the operation of the electric machinery, also ensures closed incorporation with the circular heat sink casing 102; the end casing 204 may be made of permeable or non-permeable material; in case of permeable material, a non-permeable separation ring must be disposed between the end casing 204 and a spindle to avoid creating flux loop if the spindle is made permeable; and the non-permeable separation ring is omitted if the end casing is made non-permeable;

the circular heat sink 102: made of permeable or non-permeable material, including aluminum, copper, or other non-permeable materials with good heat conduction, or permeable and heat conduction materials; when made of permeable material, the heat sink casing 102 may become an integrated part of the magnetic path among magnetic poles; when applied in DC or AC rectifier type of electric machine, an optional inverting magnetic pole may be provided as applicable; the circular heat sink casing 102 may be made in circular, polygonal or other geometric shape containing a support block 103 for the combination of the magnetic path structure 101 and the end casing 204; the support block 113 is made in a form without compromising the circulating airflow in the magnetic path; and the support block 113 may be omitted if direct combination is permitted between the circular heat sink casing 102 and the magnetic path structure 101 or the end casing 204 without comprising the circulation of the airflow; and

an airflow pump fan 112: related to an operational airflow pump fan driven by the spindle of the electric machine, or an airflow pump fan driven by an independent motor to actively pump the hotter airflow accumulated inside the electric machine to circulate inside an air chamber formed by the circular heat sink casing 204 so to facilitate the heat dissipation for the electric machine.

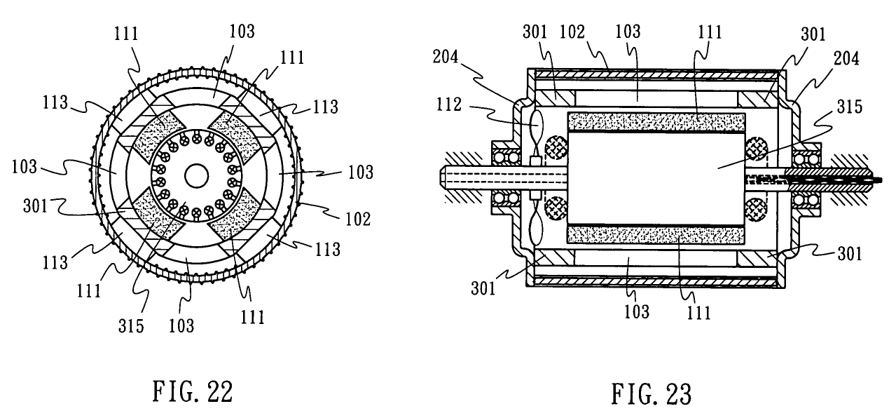

As illustrated in FIGS. 22 and 23, the ventilation slotted hole of the external rotation type of electric machine structure is comprised of one or a plurality of radius through hole as the airflow passage. FIG. 22 is a front view of an eleventh preferred embodiment of the present invention having two through holes in radius provided on the external rotor of an external rotation electric machine; and FIG. 23 is a side view of the eleventh preferred embodiment of the present invention.

The filed operation of the present invention is essentially following those principles to be stated below:

(1) Installation of inverting magnetic pole: when the electric machine relates to a DC brush electric machine and larger working scope warrants the active inverting, the inverting magnetic pole is installed; if the circular protection casing disposed at the notch coupled to where between the magnetic poles or the separately provided arc or sheet protection casing is made of a permeable material, the inverting magnetic pole may be provided as required in the inverting; if the filed magnetic path is made of approximately closed circular permeable sheet, the permeable sheet may be forthwith made one with inverting magnetic pole, or the inverting magnetic pole may be separately provided.

(2) Adaptation of the size of the opening of the filed magnetic path to that of the rotor: whereas the length and width of the rotor in adaptation to the size of the opening between magnetic poles of the structure of the magnetic path of the entire electric machine vary depending on the heat dissipation and inverting demands, certain portions of the magnetic pole from the permeable sheets closer to both sides of the magnetic files structure in the field magnetic path and the relay magnetic path comprised of laminated multiple permeable sheets are removed to reduce the axial length of the magnetic pole, or additional magnetic pole is added to a certain part of the permeable sheets of the filed magnetic path closer to the relay magnetic filed to increase the axial length of the magnetic pole as applicable.

(3) Conduction of external rotation electric machine: if the external rotation part relates to a rectifier type of electric machine structure, the conduction ring brush structure is used to transmit the electric power to the brush, rectifier and armature; if the external rotation part relates to permanent or cage type of electric machine structure, the addition of the conduction ring brush structure is not required.

(4) The cooling type for the closed enclosure electric machine provided with circumambient air chamber and radius through hole may be of having a fan built in the electric machine or of air cool provided by an externally provided and independently driven fan, or fluid cooling provided by a fluid pump and heat sink or radiator due to the specific structure features of its air duct.

(5) The radius hole structure of longitudinally slotted hole, laterally slotted hole, inclined slotted hole serving as airflow passage in various application structures of the present invention including external rotation or internal rotation type, or dual electric machine type may be related to one or a plurality of radius through hole, and may be made in any geometric form depending on the magnetic path needed and the consideration taken to facilitate the air flow in the course of rotation, or indicating inclined slotted or through hole penetrating the permeable magnetic path depending on the direction of rotation to facilitate pumping the airflow.

As disclosed above, the present invention by providing a closed enclosure electric machine adapted with circumambient air chamber and radius through hole is innovative in design, disclosing an innovative structure for the inverting features that is most vital to a DC electric machine and offering specific benefits; therefore, this application is duly filed accordingly.

1. A closed enclosure electric machine adapted with circumambient air chamber and radius through hole including an AC or DC internal or external rotation rotary electric machine or linear machine provided with magnetic pole structure; one or a plurality radius or circumambient air chamber and radius or slotted through hole disposed in the middle between abutted magnetic poles, and optionally one or a plurality of notch, through hole, or slotted through hole formed respectively at both ends at the proximate end casing along a neutral line of magnetic pole to constitute an air current passage; a circular radiation casing connecting through the internal of the electric machine via the notch, through hole or slotted hole is provided externally to the structure of the magnetic path; a space is defined between the circular heat sink casing and the outer casing of the magnetic path to admit airflow; the circular heat sink and closed enclosures at both ends of the electric machine constitute a closed enclosure electric machine to allow circulation of airflow created by the heat accumulated inside the electric machine to discharge the heat into the ambient through the casing of the circular heat sink is essentially comprised of:
a magnetic path structure 101: comprised of a permeable material, is provided with a magnetic pole 111 serving as a stator; the magnetic pole 111 relates to a permanent or winding exciting or a winding comprised of a rotation magnetic field to match another electric machine structure 115 operating as an electric machine;
the magnetic pole 111: may be comprised of a plurality of poles, one or multiple radius through hole 103 or longitudinally slotted through hole or inclined slotted hole or laterally slotted hole is disposed among the poles, one or multiple flared notch 104 or through hole or slotted through hole may be optionally provided on both ends along a neutral line of each magnetic pole at where closed to an end casing; a circular heat sink casing 102 comprised of a permeable or non-permeable material is axially provided to the outer side of the magnetic pole 111; a space is defined to allow a fluid to flow between the circular heat sink casing 102 and the magnetic path structure 101 thus to constitute a airflow passage with the radius through hole 103 or the slotted through hole from the structure of the magnetic path; meanwhile, an optional strainer 110 may be provided in the airflow passage for the hotter airflow inside the electric machine to circulate by convection thus to dissipate the accumulated heat inside the electric machine to the ambient through the circular heat sink casing 102; and both end casings 204 respectively provided at both ends of the magnetic path structure and the circular heat sink casing 102 are enclosed to each other to form a construction of closed enclosure electric machine;
the end casing 204: provided to incorporate the relatively rotary electric machine structure 115 and the magnetic path structure 101 into a construction of electric machine to provide a foundation of mechanical stability for the operation of the electric machinery, also ensures closed incorporation with the circular heat sink casing 102; the end casing 204 may be made of permeable or non-permeable material; in case of permeable material, a non-permeable separation ring must be disposed between the end casing 204 and a spindle to avoid creating flux loop if the spindle is made permeable; and the non-permeable separation ring is omitted if the end casing is made non-permeable;
the heat sink casing 102: made of permeable or non-permeable material, including aluminum, copper, or other non-permeable materials with good heat conduction, or permeable and heat conduction materials; when made of permeable material, the heat sink casing 102 may become an integrated part of the magnetic path among magnetic poles; when applied in DC or AC rectifier type of electric machine, an optional inverting magnetic pole may be provided as applicable; the circular heat sink casing 102 may be made in circular, polygonal or other geometric shape containing a support block 103 for the combination of the magnetic path structure 101 and the end casing 204; the support block 113 is made in a form without compromising the circulating airflow in the magnetic path; and the support block 113 may be omitted if direct combination is permitted between the circular heat sink casing 102 and the magnetic path structure 101 or the end casing 204 without comprising the circulation of the airflow; and
an airflow pump fan 112: related to an operational airflow pump fan driven by the spindle of the electric machine, or an airflow pump fan driven by an independent motor to actively pump the hotter airflow accumulated inside the electric machine to circulate inside an air chamber formed by the circular heat sink casing 204 so to facilitate the heat dissipation for the electric machine.

2. The closed enclosure electric machine adapted with circumambient air chamber and radius through hole as claimed in claim 1, wherein, a longitudinally slotted through hole is provided between magnetic poles to function as an airflow passage.

3. The closed enclosure electric machine adapted with circumambient air chamber and radius through hole as claimed in claim 1, wherein two longitudinally slotted through holes are made at the angular location of the electric machine at the center of two abutted magnetic poles.

4. The closed enclosure electric machine adapted with circumambient air chamber and radius through hole as claimed in claim 1, wherein one or a plurality of slotted through hole 103 is disposed between poles of the magnetic path structure 101.

5. The closed enclosure electric machine adapted with circumambient air chamber and radius through hole as claimed in claim 1, wherein one or a plurality of laterally slotted through hole is disposed between poles of the magnetic path structure 101.

6. The closed enclosure electric machine adapted with circumambient air chamber and radius through hole as claimed in claim 1, wherein a row of multiple radius through holes 103 are disposed between poles of the magnetic path structure 101.

7. The closed enclosure electric machine adapted with circumambient air chamber and radius through hole as claimed in claim 1, wherein multiple rows of radius through holes are disposed between poles of the magnetic path structure 101.

8. The closed enclosure electric machine adapted with circumambient air chamber and radius through hole as claimed in claim 1, wherein an AC motor or a generator, or in series, shunt, or compound excitement AC or AC brush motor or generator, or applied in a DC or brushless or brush motor or generator with its magnetic field comprised of a permanent magnet; the mechanical structure of the electric machine is further comprised based on electric machinery characteristics operating on the same principles of multi-pole external or internal rotation type of rotary electric machine, magnetic filed rotation type of rotary electric machine, or armature rotation type of rotary electric machine, or magnetic field and armature rotor dual rotation type of rotary electric machine; and the type of the construction of the electric machine includes cylinder, conic, or disk rotation type of rotary electric machine, or linear drive construction of the electric machine.

9. The closed enclosure electric machine adapted with circumambient air chamber and radius through hole as claimed in claim 1, wherein, the structure of the magnetic path for the electric machine is made integrated or combined components.

10. The closed enclosure electric machine adapted with circumambient air chamber and radius through hole as claimed in claim 1, wherein the structure of the magnetic path for the electric machine is made by having multiple permeable sheets laminated to form the magnetic path structure with a relay magnetic path in a construction characterized by:
a field magnetic path 202: related to one that axially extending towards the end casings in flared cross-sectional areas of different magnetic path and outer diameter is comprised of multiple permeable sheets. Though all the permeable sheets have the same outer diameter, their field magnetic paths are comprised of permeable sheets of different magnetic path widths axially laminated from the mid of the magnetic pole towards both sides, and the structure of the permeable sheet closer to the end casing has wider magnetic path so to ensure that the flux density of the field magnetic path tends to evenly distributed; the filed magnetic path structure includes a stator magnetic pole 211 comprised of multiple poles; and the magnetic pole 211 is permanent or winding excited, or winding that constitutes a rotary magnetic field so to adapt to another electric machine structure 115 engaging in relative operation of functions of an electric machine;
the magnetic pole 211: of multiple poles, one or a plurality of radius through hole 103 or slotted through hole is disposed between magnetic poles; one or a plurality of flared notch 104 or through hole or slotted through hole is made as required with its outer side surrounded by with the circular heat sink casing 102 made of permeable or non-permeable material; a space to admit flow of fluid is defined among the circular heat sink casing 102, the field magnetic path 202 and a relay magnetic path 203 to create airflow passage with the radius through hole 103 or the slotted through hole from the structure of the magnetic path; an optional strainer 110 is disposed in the airflow passage to exercise circulation by convection with the hotter airflow inside the electric machine so to dissipate the accumulated heat inside the electric machine to the ambient through the circular heat sink casing 102; and both end casings 204 respectively provided at both ends of the structure of the magnetic path are enclosed with the circular heat sink casing 102 to form a closed enclosure structure of electric machine;
the relay magnetic path 203: to be coupled to both sides of the filed magnetic path 202 for the filed magnetic path, the relay magnetic path, and a rotor between magnetic poles to constitute a closed flux for operating on electric machinery effects; the relay magnetic path may be comprised of permeable sheet indicating when viewed axially a closed loop in relation to the central location of the abutted magnetic pole to couple the filed magnetic path to the flux of the abutted magnetic pole; and the relay magnetic path is alternatively comprised of a block type of permeable material;
the end casing 204: provided to incorporate the relatively rotary electric machine structure 115 and the magnetic path structure (including the filed magnetic path 202 and the relay magnetic path 203) into a construction of electric machine to provide a foundation of mechanical stability for the operation of the electric machinery, also ensures closed incorporation with the circular heat sink casing 102; the end casing 204 may be made of permeable or non-permeable material; in case of permeable material, a non-permeable separation ring must be disposed between the end casing 204 and a spindle to avoid creating flux loop if the spindle is made permeable; and the non-permeable separation ring is omitted if the end casing is made non-permeable;
the circular heat sink 102: made of permeable or non-permeable material, including aluminum, copper, or other non-permeable materials with good heat conduction, or permeable and heat conduction materials; when made of permeable material, the heat sink casing 102 may become an integrated part of the magnetic path among magnetic poles; when applied in DC or AC rectifier type of electric machine, an optional inverting magnetic pole may be provided as applicable; the circular heat sink casing 102 may be made in circular, polygonal or other geometric shape containing a support block 103 for the combination of the magnetic path structure 101 and the end casing 204; the support block 113 is made in a form without compromising the circulating airflow in the magnetic path; and the support block 113 may be omitted if direct combination is permitted between the circular heat sink casing 102 and the magnetic path structure 101 or the end casing 204 without comprising the circulation of the airflow; and
an airflow pump fan 112: related to an operational airflow pump fan driven by the spindle of the electric machine, or an airflow pump fan driven by an independent motor to actively pump the hotter airflow accumulated inside the electric machine to circulate inside an air chamber formed by the circular heat sink casing 204 so to facilitate the heat dissipation for the electric machine.

11. The closed enclosure electric machine adapted with circumambient air chamber and radius through hole as claimed in claim 1, wherein the magnetic path structure is comprised of having the magnetic poles to be comprised of laminated multiple permeable sheets leaving the remaining magnetic path made in block structure.

12. The closed enclosure electric machine adapted with circumambient air chamber and radius through hole as claimed in claim 1, wherein it is essentially comprised of:
a structure of magnetic path 301: relates to a rotor mounted to the external rotation part of the electric machine to function as an electric machine; the external rotation part of the electric machine is comprised of permanent or winding magnetic pole or rectifier type armature or cage rotor; the magnetic pole of the external rotation part of the electric machine may be comprised of multiple poles to engage in interactive rotation with a stationary part 315 of a stationary electric machine of relative motion; the stationary part 315 of the stationary electric machine serves as a stator of the electric machine with its electric machine structure of the magnetic filed permanent or winding excited, or of winding constituting rotary magnetic filed depending on the structural type of the external rotation part of the adapted electric machine; the magnetic path structure 301 is comprised of material of good permeability to transmit the flux among magnetic poles of the external rotation part of the electric machine, one or a plurality radius through hole 103 or longitudinally slotted through hole or inclined slotted hole or laterally slotted hole is provided between magnetic poles; one or multiple flared notch 104 or through hole or slotted through hole may be optionally provided on both ends along a neutral line of each magnetic pole at where closed to an end casing to create an airflow passage; a circular heat sink casing is disposed externally to the magnetic path structure; a space is defined between the circular heat sink casing and the outer casing of the magnetic path to admit airflow; the space is also connecting through inside the electric machine through the airflow passage formed by the notch, through hole or slotted through hole; both circular heat sink casings and the both closed ends of the electric machine constitute a structure of closed enclosure electric machine for the hotter airflow accumulated inside the electric machine to circulate through the airflow passage and dissipated into the ambient through the circular heat sink casing;
the end casing 204: provided to incorporate the magnetic path 301 and the stator 315 of stationary electric machine into a construction of electric machine to provide a foundation of mechanical stability for the operation of the electric machinery, also ensures closed incorporation with the circular heat sink casing 102; the end casing 204 may be made of permeable or non-permeable material; in case of permeable material, a non-permeable separation ring must be disposed between the end casing 204 and a spindle to avoid creating flux loop if the spindle is made permeable; and the non-permeable separation ring is omitted if the end casing is made non-permeable;
the circular heat sink 102: made of permeable or non-permeable material, including aluminum, copper, or other non-permeable materials with good heat conduction, or permeable and heat conduction materials; when made of permeable material, the heat sink casing 102 may become an integrated part of the magnetic path among magnetic poles; when applied in DC or AC rectifier type of electric machine, an optional inverting magnetic pole may be provided as applicable; the circular heat sink casing 102 may be made in circular, polygonal or other geometric shape containing a support block 103 for the combination of the magnetic path structure 101 and the end casing 204; the support block 113 is made in a form without compromising the circulating airflow in the magnetic path; and the support block 113 may be omitted if direct combination is permitted between the circular heat sink casing 102 and the magnetic path structure 101 or the end casing 204 without comprising the circulation of the airflow; and
an airflow pump fan 112: related to an operational airflow pump fan driven by the spindle of the electric machine, or an airflow pump fan driven by an independent motor to actively pump the hotter airflow accumulated inside the electric machine to circulate inside an air chamber formed by the circular heat sink casing 204 so to facilitate the heat dissipation for the electric machine.

13. The closed enclosure electric machine adapted with circumambient air chamber and radius through hole as claimed in claim 1, the air ventilation slotted hole of the external rotation type of electric machine structure has one or a plurality of radius through hole to function as the airflow passage.

14. The closed enclosure electric machine adapted with circumambient air chamber and radius through hole as claimed in claim 1, wherein when the electric machine relates to a DC brush electric machine and larger working scope warrants the active inverting, the inverting magnetic pole is installed; if the circular protection casing disposed at the notch coupled to where between the magnetic poles or the separately provided arc or sheet protection casing is made of a permeable material, the inverting magnetic pole may be provided as required in the inverting; if the filed magnetic path is made of approximately closed circular permeable sheet, the permeable sheet may be forthwith made one with inverting magnetic pole, or the inverting magnetic pole may be separately provided.

15. The closed enclosure electric machine adapted with circumambient air chamber and radius through hole as claimed in claim 1, wherein certain portions of the magnetic pole from the permeable sheets closer to both sides of the magnetic files structure in the field magnetic path and the relay magnetic path comprised of laminated multiple permeable sheets are removed to reduce the axial length of the magnetic pole, or additional magnetic pole is added to a certain part of the permeable sheets of the filed magnetic path closer to the relay magnetic filed to increase the axial length of the magnetic pole as applicable.

16. The closed enclosure electric machine adapted with circumambient air chamber and radius through hole as claimed in claim 1, wherein if the external rotation part relates to a rectifier type of electric machine structure, the conduction ring brush structure is used to transmit the electric power to the brush, rectifier and armature; if the external rotation part relates to permanent or cage type of electric machine structure, the addition of the conduction ring brush structure is not required.

17. The closed enclosure electric machine adapted with circumambient air chamber and radius through hole as claimed in claim 1, wherein the cooling type for the closed enclosure electric machine provided with circumambient air chamber and radius through hole may be of having a fan built in the electric machine or of air cool provided by an externally provided and independently driven fan, or fluid cooling provided by a fluid pump and heat sink or radiator due to the specific structure features of its air duct.

18. The closed enclosure electric machine adapted with circumambient air chamber and radius through hole as claimed in claim 1, wherein the radius hole structure of longitudinally slotted hole, laterally slotted hole, inclined slotted hole serving as airflow passage in various application structures of the present invention including external rotation or internal rotation type, or dual electric machine type may be related to one or a plurality of radius through hole, and may be made in any geometric form depending on the magnetic path needed and the consideration taken to facilitate the air flow in the course of rotation, or indicating inclined slotted or through hole penetrating the permeable magnetic path depending on the direction of rotation to facilitate pumping the airflow
